(19) United States
(12) Patent Application Publication
(10) Pub. No.: US 2010/0041793 A1
(43) Pub. Date: Feb. 18, 2010

(54) PARTICLE-MATRIX COMPOSITION COATED WITH MIXTURE COMPRISING POLYSULFIDE POLYMER

(75) Inventors: Sebastianus Christoffel Josephus PIERIK, Lent (NL); Rabindra Nath DATTA, Schalkhaar (NL); Sumana Datta, Schalkhaar (NL)

Correspondence Address: OLIFF & BERRIDGE, PLC, P.O. BOX 320850, ALEXANDRIA, VA, 22320-4850, US

(73) Assignee: TEIJIN ARAMID B.V., Arnhem (NL)

(21) Appl. No.: 12/504,461

(22) Filed: Jul. 16, 2009

Related U.S. Application Data
(63) Continuation-in-part of application No. 12/310,672, now abandoned.

(30) Foreign Application Priority Data
Oct. 6, 2006 (EP) 06021011.9

(51) Int. Cl. C08K 9/04

(52) U.S. Cl. 523/205

(57) ABSTRACT

The invention pertains to a composition comprising a particle and a matrix, wherein the particle is at least partially coated with a compound or a mixture of compounds a cured polysulfide polymer obtained from a polysulfide polymer having at least two epoxy end groups.

Most preferred polysulfide polymers are:

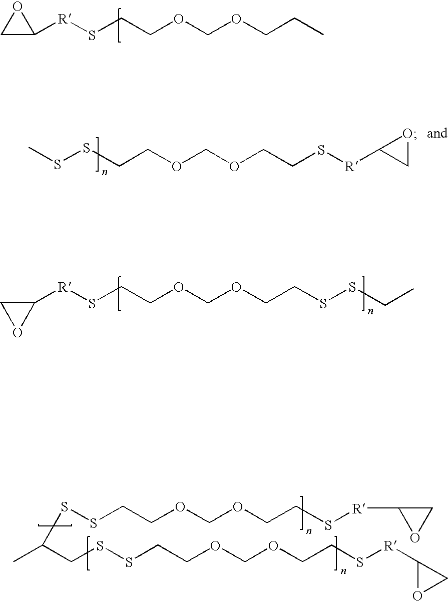

wherein n is independently 1-200 and R′ is

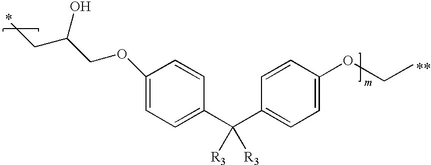

wherein m is 0 to 10, R₃ is independently H or CH₃, and the end indicated with the double asterisk is bonded to the epoxide group.

The invention further relates to particle-elastomers comprising said composition, and skim products, tires, tire treads, and belts comprising these particle-elastomers.

The invention pertains to a composition comprising a particle and a matrix, wherein the particle is at least partially coated with a mixture of compounds, and to a particle-elastomer composition. The invention further relates to a skim product, a tire, a tire tread, and belt comprising said particle-elastomer composition.

In the tire and belt industry, among others, better mechanical, heat build up and hysteresis properties are being demanded. It has long been known that the mechanical properties of rubber can be improved by using a large amount of sulfur as a cross-linking agent to increase the crosslink density in vulcanized rubbers. However, the use of large amounts of sulfur suffers from the disadvantage of high heat generation that leads to a marked decrease in heat resistance and resistance to flex cracking, among other properties, in the final product. In order to eliminate the foregoing disadvantage, it was proposed to add treated chopped fiber, pellets made thereof or treated pellets, particularly treated with polysulfides, Bunte salt, and sulfur to sulfur-vulcanization systems. These pellets further contain wax to improve processing.

In JP 66008866 it was disclosed to use benzothiazole sulfide as adhesive promoters for polyamide fibers. This method, however, does not provide tires and belts having low crack growth, low loss modulus, and low tangent delta. In JP 56129280, JP 60072928, JP 60072929 and JP 60072972, polysulfide polymers are applied as a part of and adhesive system to adhere fibers such as polyester and aramid fibers to rubber. None of these methods provide tires and belts having low crack growth, low loss modulus, and low tangent delta.

Waxed pellets as such are known in the art. For instance, in EP 0 889 072 the coating of aramid pellets with a polymeric component, e.g. a wax, was disclosed. These pellets are however not coated with a polysulfide polymer containing wax.

In U.S. Pat. No. 6,068,922 pellets comprising aramid fibers and an extrudable polymer, e.g. polyethylene, polypropylene or polyamides are disclosed. The fibers may be coated by typical sizing agents (RF, epoxy, silicone), but polysulfide polymer coating is not mentioned.

The present invention provides a solution to the above problems by the use of a novel class of treated particles, such as chopped fibers, staple fiber, pulp, or powder, in the sulfur vulcanization of rubbers and provides in a particle and a pellet thereof that solves a long-standing problem of reducing hysteresis and heat generation in rubber compositions.

To this end the invention relates to a composition comprising a particle and a matrix, wherein the particle is at least partially coated with a compound or a mixture of compounds comprising a cured polysulfide polymer obtained from a polysulfide polymer having at least two epoxy end groups.

More preferably, the composition comprises a linear or branched polysulfide polymer compound having the formula A-B-C, wherein B is a moiety comprising independently 1-200 repeating units of the formula.

—[X—R₂—X—R₁—Sₓ]—

wherein

X is independently CH₂, S or O;

x is 2, 3, or 4;

R₁ and R₂ are independently selected from substituted or unsubstituted alkylene with 1 to 10 carbon atoms, substituted or unsubstituted arylene with 6 to 10 carbon atoms, alkyleneoxy with 1 to 5 carbon atoms, and alkyleneoxyalkylene with 2 to 10 carbon atoms; wherein the substituent is the moiety comprising independently 1-200 repeating units of the formula:

D-[X—R₂—X—R₁—Sₓ]-E

wherein X, R₁, R₂, and x have the previously given meanings;

or X, R₁ and R₂ are independently a bond with the proviso that the moiety X—R₂—X—R₁ contains at least 2 atoms;

A and C are independently selected from hydrogen and groups containing at least one of halogen, epoxy, hydroxy, isocyanate, silyl, and vinyl; and

one of D and E is a bond and the other has the same meaning as A.

This compound can have an essentially linear molecular structure but may have a partially branched linear structure as well. In the above formula, if R₁ and/or R₂ have the meaning substituted alkylene with 1 to 10 carbon atoms, or substituted arylene with 6 to 10 carbon atoms, the substituent is the moiety comprising independently 1-200 repeating units of the formula D-[X—R₂—X—R₁—Sₓ]-E, and groups R₁ and R₂ in said repeating unit is independently selected from alkylene with 1 to 10 carbon atoms, arylene with 6 to 10 carbon atoms, alkyleneoxy with 1 to 5 carbon atoms, and alkyleneoxyalkylene with 2 to 10 carbon atoms.

X is preferably selected from S and O. The alkylene group can be exemplified by methylene, ethylene, propylene, isopropylene, butylenes, isobutylene, neopentylene, hexylene, and the like. The arylene group can be exemplified by phenylene, benzylene, or methylbenzylene, and the like, while the moiety X—R₂—X—R₁— can be alkyleneoxyalkylene group, such as methyleneoxymethylene, ethyleneoxyethylene, methyleneoxyethyleneoxy, ethyleneoxyethyleneoxy, and propenyloxypropylene, and the like, wherein the oxy group can be replaced by sulfide. Specific examples, for instance, can be represented by the following formulae:

—CH₂OCH₂OCH₂—; —C₂H₄OCH₂OC₂H₄—; —C₂H₄OC₂H₄OC₂H₄—; —C₃H₆OCH₂OC₃H₆—; —C₂H₄OC₂H₄OC₂H₄OC₂H₄—; —CH₂SCH₂SCH₂—; —C₂H₄SCH₂SC₂H₄—; —C₂H₄SCH₂SC₂H₄—; —C₂H₄OC₂H₄SC₂H₄OC₂H₄—.

The most preferable divalent organic group X—R₂—X—R₁— is the one expressed by the following formula: —C₂H₄OCH₂OC₂H₄—.

The aforementioned divalent organic groups can be branched by the substituent comprising independently 1-200 repeating units of the formula:

D-[X—R₂—X—R₁—Sₓ]-E

wherein X, R₁, R₂, and x have the previously given meanings.

Examples of reactive end groups A and C (and/or D and E) include but are not limited to epichlorohydrin, glycidylether of bisphenol A, vinyl triethoxysilane, and (3-glycidyloxypropyl)trimethoxysilane. Most preferred groups A and C are H, glycidyl and the reaction product of the polysulfide polymer wherein A or C is H and the reactive compound glycidylether of bisphenol A or F. Slightly branched and unbranched polysulfide polymers having 5 to 38 repeating units are commercially available under the tradenames Thioplast™ EPS, and Thiokol® ELP.

Among the most preferred polysulfide polymers are the commercially available polymers of the structure:

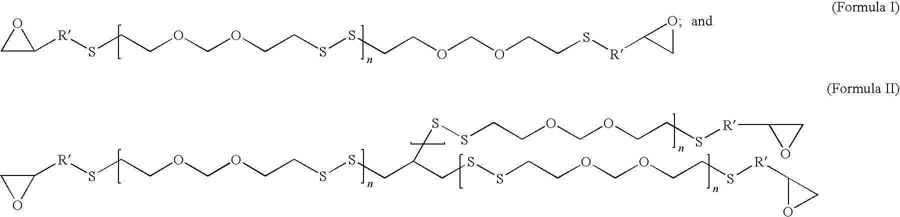

wherein n is independently 1-200 and R′ is

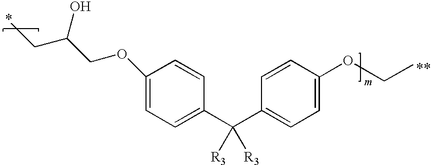

wherein m is 0 to 10, R₃ is independently H or CH₃, and the end indicated with the double asterisk is bonded to the epoxide group.

For polysulfide polymer carrying glycidyl functionality a choice can be made from any epoxy curing system known in the art. Examples of curing agents include but are not limited to polyols, such as polyvinylalcohol and polyetherpolyols, polyacid anhydride, polycarboxylic acid, polyisocyanates, and primary amines. In some cases an additional catalyst is required for curing to take place. Furthermore, the polysulfide polymer carrying at least two glycidyl groups can be cured to themselves without adding a curing system. The term “cured” polysulfide polymer having at least two epoxy end groups means that the polysulfide polymer molecule having at least two epoxy end groups is at least partially coupled to another polysulfide polymer molecule having at least two epoxy end groups through their glycidyl groups.

In a preferred embodiment the invention relates to a composition comprising a particle and a matrix having enhanced rubber properties in an elastomer. The matrix may be a wax or a polymer. The composition contains up to 85 wt. % of matrix, preferably wax, based on the weight of the composition. Examples of suitable waxes are microcrystalline wax of higher alkyl chains, such as a C22-C38 alkyl chain, paraffin wax or alkyl long chain fatty acid waxes, such as C12-C40 alkanecarboxylic acids. Instead of a wax, the matrix can also be selected from an extrudable polymer. Particularly useful are, edgy polyethylene, polypropylene or polyamides, or mixtures of such extrudable polymers and wax. The extrudable polymers may be modified or unmodified polymers and copolymers.

The composition comprising the coated particles can be in the form of the particle as such, or may be compressed by conventional means to a pellet. Alternatively, the particles may be contained in a matrix and shaped into a pellet, for instance by cutting the particle-matrix composition to pellets.

The pellet may be composed of any particle according to the invention. Preferred particles are selected from aramid, polyester, polyamide, cellulose, glass, and carbon. The particles may be in any form such as chopped fiber, staple fiber, pulp, fibrils, fibrid, beads, powder, and the like. Aramid fibers (which include chopped fiber, staple fiber, and pulp) and powders have the preference, more specifically particles of poly(p-phenylene-terephthalamide) or co-poly-(paraphenylene/3,4′-oxydiphenylene terephthalamide. Most preferred are chopped fiber, staple fiber, and powder. Powder and beads have the additional advantage that they do not need a spinning step and can directly be obtained form the polymer.

The term “pellet” includes terms, apart from pellet, that are synonymous or closely related such as tablet, briquette, pastilles, granule and the like.

Pellets can be made from any particle, including short cut fibers, chopped fiber, staple fiber, pulp, fibrils, fibrid, beads, and powder, by mixing these particles with a matrix of a wax and/or an extrudable polymer and the coating chemicals.

For instance, the pellet can be prepared according to the method described in WO 0058064. Alternatively, pellets can be prepared directly using chopped fiber or powder and the like, wax, polysulfide polymer and, if necessary, the polysulfide curing system. The particles and the wax and/or extrudable polymer matrix, and optionally the curing agent, and other chemicals are mixed intensively and optionally heated up to a temperature at or above the melting point of the wax or extruded polymer. Then the mixture is formed into the shape of a pellet or tablet at a temperature below the melting point of the wax or extruded polymer. Wax (and/or extrudable polymer) can be used in amounts up to 85 wt. % based upon the weight of the composition. Alternatively, pellets can also be made from a mixture of particle and matrix, after which the polysulfide polymer and the curing system; and/or the cured polysulfide polymer is added to at least partially coat the particles contained in the pellet.

Compositions of the invention can also contain a wax as a carrier medium to improve processing. Examples of suitable waxes are microcrystalline wax of higher alkyl chains, such as C22-C38 alkyl chains, paraffin wax or alkyl long chain fatty acid waxes, such as C12-C40 alkanecarboxylic acids. After treatment the composition may be used as such or may be comminuted to appropriate size, to be suitably used in rubber compounds. After treatment fibers may be chopped to appropriate length, for use in rubber compounds, or chopped fiber may be treated by the above chemicals, or chopped fibers and the above chemicals including a wax may be mixed, optionally heated and formed into a well dosable shape.

Alternatively, the treatment of particles, including fiber and powder, or pellets made thereof, can be based on glycidyl functional polysulfide polymer where no further curing agents are required.

A suitable coating amounts 0.5-50 wt. % based on the weight of composition, preferably 1-30 wt. %, more preferably 2-15 wt. %.

Compositions comprising polysulfide polymer having glycidyl end groups may be given a heat treatment. Preferably, compositions are heated during 1 to 60 minutes at a temperature from 80 to 200° C. More preferably, compositions are heated during 5 to 25 minutes at a temperature from 120 to 170° C.

In another aspect the invention relates to a rubber composition which is the vulcanization reaction product of a rubber, sulfur and optionally sulfur donor, and the composition according to the invention. The composition of the invention acts as a modulus enhancer, strength improver, as well lowers hysteresis. Also disclosed is a vulcanization process carried out in the presence of the composition and the use of these compositions in the sulfur-vulcanization of rubbers.

In addition, the present invention relates to a vulcanization process carried out in the presence of the compositions and the use of these compositions in the sulfur-vulcanization of rubbers. Further, the invention also encompasses rubber products which comprise at least some rubber which has been vulcanized, preferably vulcanized with sulfur, in the presence of said compositions.

The present invention provides excellent hysteresis behavior as well as improvements in several rubber properties without having a significant adverse effect on the remaining properties, when compared with similar sulfur-vulcanization systems without any of the composition.

The present invention is applicable to all natural and synthetic rubbers. Examples of such rubbers include, but are not limited to, natural rubber, styrene-butadiene rubber, butadiene rubber, isoprene rubber, acrylonitrile-butadiene rubber, chloroprene rubber, isopreneisobutylene rubber, brominated isoprene-isobutylene rubber, chlorinated isoprene-isobutylene rubber, ethylene-propylene-diene ter-polymers, as well as combinations of two or more of these rubbers and combinations of one or more of these rubbers with other rubbers and/or thermo-plastics.

Sulfur, optionally together with sulfur donors, provides the required level of sulfur during the vulcanization process. Examples of sulfur which may be used in the vulcanization process include various types of sulfur such as powdered sulfur, precipitated sulfur and insoluble sulfur. Examples of sulfur donors include, but are not limited to, tetramethylthiuram disulfide, tetraethylthiuram disulfide, tetrabutylthiuram disulfide, dipentamethylene thiuram hexasulfide, dipentamethylene thiuram tetrasulfide, dithiodimorpholine, and mixtures thereof.

Sulfur donors may be used instead or in addition to the sulfur. Herein the term “sulfur” shall further also include the mixture of sulfur and sulfur donor(s). Further, references to the quantity of sulfur employed in the vulcanization process, when applied to sulfur donors, mean a quantity of sulfur donor which is required to provide the equivalent amount of sulfur that is specified.

More particularly, the present invention relates to a sulfur-vulcanized rubber composition which comprises the vulcanization reaction product of: (a) 100 parts by weight of at least one natural or synthetic rubber; (b) 0.1 to 25 parts by weight of an amount of sulfur, or sulfur and/or a sulfur donor, to provide the equivalent of 0.1 to 25 parts by weight of sulfur; and (c) 0.1 to 20 parts by weight of the composition of the invention, preferably comprising powder, chopped fiber, staple fiber, or pellets made thereof.

The particle of the present invention is based on natural and synthetic polymers. Examples of such polymers include, but not limited to, aramid, such as para-aramid, polyamide, polyester, cellulose, such as rayon, glass, and carbon as well as combinations of two or more of these yarns.

Most preferably the particle is poly(para-phenylene-terephthalamide) fiber, which is commercially available under the trade name Twaron®, or co-poly-(paraphenylene/3,4′-oxydiphenylene terephthalamide), which is commercially available under the trade name Technora®.

The amount of sulfur to be compounded with the rubber is, based on 100 parts of rubber, usually 0.1 to 25 parts by weight, and more preferably 0.2 to 8 parts by weight. The amount of sulfur donor to be compounded with the rubber is an amount to provide an equivalent amount of sulfur, i.e. an amount which gives the same amount of sulfur, as if sulfur itself were used. The amount of composition to be compounded with the rubber is, based on 100 parts of rubber, 0.1 to 25 parts by weight, and more preferably 0.2 to 10.0 parts by weight, and most preferably 0.5 to 5 parts by weight. These ingredients may be employed as a pre-mix, or added simultaneously or separately, and they may be added together with other rubber compounding ingredients as well. In most circumstances it is also desirable to have a vulcanization accelerator in the rubber compound. Conventional, known vulcanization accelerators may be employed. The preferred vulcanization accelerators include mercaptobenzothiazole, 2,2′-mercaptobenzothiazole disulfide, sulfenamide accelerators including N-cyclohexyl-2-benzothiazole sulfenamide, N-tert-butyl-2-benzothiazole sulfenamide, N,N-dicyclohexyl-2-benzothiazole sulfenamide, and 2-(morpholinothio)benzothiazole; thiophosphoric acid derivative accelerators, thiurams, dithiocarbamates, diphenyl guanidine, diorthotolyl guanidine, dithiocarbamylsulfenamides, xanthates, triazine accelerators and mixtures thereof.

If the vulcanization accelerator is employed, quantities of from 0.1 to 8 parts by weight, based on 100 parts by weight of rubber composition, are used. More preferably, the vulcanization accelerator comprises 0.3 to 4.0 parts by weight, based on 100 parts by weight of rubber. Other conventional rubber additives may also be employed in their usual amounts. For example, reinforcing agent such as carbon black, silica, clay, whiting, and other mineral fillers, as well as mixtures of fillers, may be included in the rubber composition. Other additives such as process oils, tackifiers, waxes, antioxidants, antiozonants, pigments, resins, plasticizers, process aids, factice, compounding agents and activators such as stearic acid and zinc oxide may be included in conventional, known amounts. For a more complete listing of rubber additives which may be used in combination with the present invention see, W. Hofmann, “Rubber Technology Handbook, Chapter 4, Rubber Chemicals and Additives, pp. 217-353, Hanser Publishers, Munich 1989.

Further, scorch retarders such as phthalic anhydride, pyromellitic anhydride, benzene hexacarboxylic trianhydride, 4-methylphthalic anhydride, trimellitic anhydride, 4-chlorophthalic anhydride, N-cyclohexyl-thiophthalimide, salicylic acid, benzoic acid, maleic anhydride and N-nitrosodiphenylamine may also be included in the rubber composition in conventional, known amounts. Finally, in specific applications it may also be desirable to include steel-cord adhesion promoters such as cobalt salts and dithiosulfates in conventional, known quantities.

The process is carried out at a temperature of 110-220° C. over a period of up to 24 hours. More preferably, the process is carried out at a temperature of 120-190° C. over a period of up to 8 hours in the presence of 0.1 to 20 parts by weight of the composition, more specifically, compositions comprising chopped fiber, staple fiber or pellet. Even more preferable is the use of 0.2-5 parts by weight of coated chopped fiber, coated staple fiber or fiber pellet made thereof. All of the additives mentioned above with respect to the rubber composition may also be present during the vulcanization process of the invention.

In a more preferred embodiment of the vulcanization process, the vulcanization is carried out at a temperature of 120-190° C. over a period of up to 8 hours and in the presence of 0.1 to 8 parts by weight, based on 100 parts by weight of rubber, of at least one vulcanization accelerator.

The present invention also includes articles of manufacture, such as skim products, tires, tire treads, tire undertreads, or belts, which comprise sulfur-vulcanized rubber which is vulcanized in the presence of the composition of the present invention.

The invention is further illustrated by the following examples which are not to be construed as limiting the invention in any way.

Experimental Methods

In the following examples, rubber compounding, vulcanization and testing was carried out according to standard methods except as otherwise stated: Base compounds were mixed in a Farrel Bridge™ BR 1.6 liter Banbury type internal mixer (preheating at 50° C., rotor speed 77 rpm, mixing time 6 min with full cooling).

Vulcanization ingredients were added to the compounds on a Schwabenthan PolyMix™ 150 L two-roll mill (friction 1:1.22, temperature 70° C., 3 min).

Cure characteristics were determined using a Monsanto™ rheometer MDR 2000E (arc 0.5°) according to ISO 6502/1999. Delta S is defined as extent of crosslinking and is derived from subtraction of lowest torque (ML) from highest torque (MH). Sheets and test specimens were vulcanized by compression molding in a Fontyne™ TP-400 press.

Tensile measurements were carried out using a Zwick™ 1445 tensile tester (ISO-2 dumbbells, tensile properties according to ASTM D 412-87, tear strength according to ASTM D 624-86).

Abrasion was determined using a Zwick abrasion tester as volume loss per 40 m path traveled (DIN 53516).

Heat build-up and compression set after dynamic loading were determined using a Goodrich™ Flexometer (load 1 MPa, stroke 0.445 cm, frequency 30 Hz, start temperature 100° C., running time 120 min or till blow out; ASTM D 623-78).

Dynamic mechanical analyses, for example loss modulus and tangent delta (Table 5) were carried out using an Eplexor™ Dynamic Mechanical Analyzer (pre-strain 10%, frequency 15 Hz, ASTM D 2231).

### EXAMPLE 1

Aramid staple pellets were prepared according to WO 0058064 and contained 80 wt. % Twaron and 20 w % polyamide resin. The treatment of these pellets was done in the following way:

Thioplast™ EPS 25 and Thioplast™ EPS 70 are commercially available from Akzo Nobel Thioplast. Thioplast™ EPS 25 is a blend of polysulfide polymers of formula I and II, wherein R′ is —CH₂— and n is smaller than 7 with a viscosity of 2 to 3 Pa·s and a degree of branching of 2 mole %. Thioplast™ EPS 70 is a slightly branched polysulfide polymer having the above formula wherein R′— epoxide is the group that is obtained by reacting diglycidylether of bisphenol A or F with the polysulfide polymer precursor having the same formula but wherein R′ is replaced by H, and n is smaller than 7 with a viscosity of 5 to 10 Pa·s at 20° C. and a branching of 0.57. Thioplast™ EPS was dissolved in toluene in the presence of a small amount of isohexadecane resulting in a solution of 66 wt. % Thioplast™ EPS and 2.6 wt. % isohexadecane in toluene. A 2.3 wt. % solution of surfactant Elfapur™ LM 75 S in water was prepared. Under vigorous stirring the Thioplast™ solution was added to the aqueous solution followed by the application of an ultraturrax resulting in a stable dispersion comprising approximately 8 wt. % Thioplast™ EPS.

About 25 g of para-aramid pellets were dipped in 110 mL of the above dispersion for about 5 minutes, after which the treated pellets were filtered off and dried.

After being dried, pellets were heat treated at 150° C. for 15 minutes.

The p-aramid fiber pellet compositions are summarized in Table 1.

TABLE 1
Aramid fiber compositions and treatments.

| Particle:matrix:polysulfide polymer | | | |
|---|---|---|---|
| (wt. %:wt. %:wt. %) | Treatment | Remark | Entry |
| Twaron:PA:EPS 25 = 71.4:17.9:10.7 | none | comparison | T1 |
| Twaron:PA:EPS 70 = 69.0:17.2:13.8 | none | comparison | T2 |
| Twaron:PA:EPS 25 = 73.1:18.3:8.6 | 15′, 150° C. | invention | T3 |
| Twaron:PA:EPS 70 = 75.5:18.9:5.6 | 15′, 150° C. | invention | T4 |

PA = polyamide resin; EPS 25 = Thioplast EPS 25; EPS 70 = Thioplast EPS 70.

The accelerator employed was N-cyclohexyl-2-benzothiazole sulfenamide (CBS). Details of the formulations are listed in Table 2.

TABLE 2
Rubber formulations incorporating aramid fiber compositions

| | Experiment | | | | | |
|---|---|---|---|---|---|---|
| Ingredients | A | B | C | D | 1 | 2 |
| NR SMR 10 | 80 | 80 | 80 | 80 | 80 | 80 |
| BR Buna CB 24 | 20 | 20 | 20 | 20 | 20 | 20 |
| Black N-339 | 55 | 57 | 55 | 55 | 55 | 55 |
| Zinc oxide | 5 | 5 | 5 | 5 | 5 | 5 |
| Stearic acid | 2 | 2 | 2 | 1.5 | 2 | 1.5 |
| Aromatic oil | 8 | 8 | 8 | 8 | 8 | 8 |
| Antidegradant 6PPD | 2 | 2 | 2 | 2 | 2 | 2 |
| Antioxidant TMQ | 1 | 1 | 1 | 1 | 1 | 1 |
| Accelerator CBS | 1.5 | 1.5 | 1.5 | 1.5 | 1.5 | 1.5 |
| sulfur | 1.5 | 1.5 | 1.5 | 1.5 | 1.5 | 1.5 |
| T1 | 0 | 0 | 1 | 0 | 0 | 0 |
| T2 | 0 | 0 | 0 | 1 | 0 | 0 |
| T3 | 0 | 0 | 0 | 0 | 1 | 0 |
| T4 | 0 | 0 | 0 | 0 | 0 | 1 |

NR is natural rubber; BR is polybutadiene; 6PPD is N-1,3-dimethylbutyl-N′-phenyl-p-phenylenediamine, TMQ is polymerized 2,2,4-trimethyl-1,2-dihydoquinoline antioxidant, CBS is N-cyclohexyl benzothiazyl sulfenamide.

The vulcanized rubbers listed in Table 2 were tested according to ASTM/ISO norms. A and B are control experiments (rubber only), C and D are comparison experiments (uncured) and 1 and 2 are experiments according to the invention. The results are given in Tables 3-6.

TABLE 3
Effect of the mixes at 100° C. on processing
characteristics (Mooney viscosity).

| Experiment | A | B | C | D | 1 | 2 |
|---|---|---|---|---|---|---|
| ML(1 + 4), MU | 54 | 55 | 57 | 55 | 59 | 59 |

The data of Table 3 show that the fiber compositions according to the invention show low viscosity as evidenced from the ML (1+4) values.

TABLE 4
Effect of the mixes at 150° C. on delta torque.

| Experiment | A | B | C | D | 1 | 2 |
|---|---|---|---|---|---|---|
| Delta S, Nm | 1.75 | 1.79 | 1.83 | 1.78 | 1.82 | 1.80 |

The data in Table 4 show that the compositions according to the invention (mix 1 and 2) do not influence the extent of crosslinking as demonstrated by delta S values.

TABLE 5
Evaluation of fibers compositions for
improvement in mechanical properties

| Experiment | A | B | C | D | 1 | 2 |
|---|---|---|---|---|---|---|
| Modulus, 300%, MPa | 13.1 | 14.8 | 14.8 | 14.5 | 15.6 | 15.4 |
| Tear strength, kN/m | 135 | 123 | 93 | 103 | 122 | 108 |

It is clear from the data depicted in Table 5 that the compositions of the invention containing polysulfide polymer (mix 1 and 2) have better modulus and tear strength.

TABLE 6
Evaluation of improvement in dynamic mechanical properties

| Experiment | A | B | C | D | 1 | 2 |
|---|---|---|---|---|---|---|
| Temperature | 27 | 29 | 26 | 28 | 26 | 28 |
| rise, ° C. | | | | | | |
| Blow out time, | 55 | 41 | 43 | 35 | 42 | 45 |
| min | | | | | | |
| Loss modulus, | 1.18 | 1.33 | 1.21 | 1.25 | 1.05 | 1.09 |
| MPa | | | | | | |
| Tangent delta | 0.156 | 0.167 | 0.159 | 0.156 | 0.136 | 0.138 |

It is noted that the compositions containing polysulfide polymer (mix 1 and 2) showed improved dynamic mechanical properties.

1. A composition comprising a particle and a matrix, wherein the particle is at least partially coated with a compound or a mixture of compounds comprising a cured polysulfide polymer obtained from a polysulfide polymer having at least two epoxy end groups.

2. The composition of claim 1 wherein the particle is a fiber, fibrid, fibril, powder or bead.

3. The composition of claim 1 wherein the polysulfide polymer is a linear or branched compound having the formula A-B-C, wherein B is a moiety comprising independently 1-200 repeating units of the formula:
—[X—R₂—X—R₁—Sₓ]—
wherein
X is independently CH₂, S or O;
x is 2, 3, or 4;
R₁ and R₂ are independently selected from substituted or unsubstituted alkylene with 1 to 10 carbon atoms, substituted or unsubstituted arylene with 6 to 10 carbon atoms, alkyleneoxy with 1 to 5 carbon atoms, and alkyleneoxyalkylene with 2 to 10 carbon atoms; wherein the substituent is the moiety comprising independently 1-200 repeating units of the formula:
D-[X—R₂—X—R₁—Sₓ]-E
wherein X, R₁, R₂, and x have the previously given meanings;
or X, R₁ and R₂ are independently a bond with the proviso that the moiety X—R₂—X—R₁ contains at least 2 atoms;
A and C are independently selected from hydrogen and groups containing at least one of halogen, epoxy, hydroxy, isocyanate, silyl, and vinyl; and
one of D and E is a bond and the other has the same meaning as A.

4. The composition of claim 3 wherein if R₁ and/or R₂ have the meaning substituted alkylene with 1 to 10 carbon atoms, or substituted arylene with 6 to 10 carbon atoms, wherein the substituent is the moiety comprising independently 1-200 repeating units of the formula D-[X—R₂—X—R₁—Sₓ]-E, groups R₁ and R₂ in said repeating unit are independently selected from alkylene with 1 to 10 carbon atoms, arylene with 6 to 10 carbon atoms, alkyleneoxy with 1 to 5 carbon atoms, and alkylencoxyalkylene with 2 to 10 carbon atoms.

5. The composition of claim 3, wherein groups A, C, D, and/or E of polysulfide polymer A-B-C are glycidyl or a group obtained by reaction of the diglycidylether of bisphenol A or the diglycidylether of bisphenol F, or a resin thereof, with the proviso that one of D and E is a bond and the other is H, and both A and C are H.

6. The composition of claim 3 wherein the polysulfide polymer is at least one of 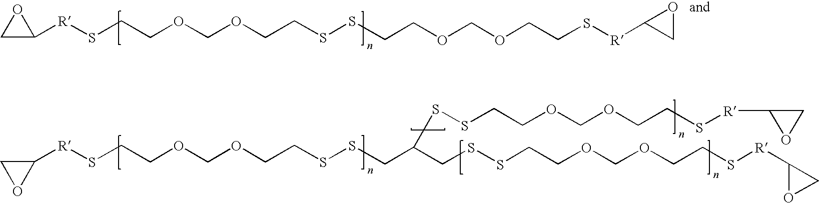
wherein n is independently 1-200 and R′ is 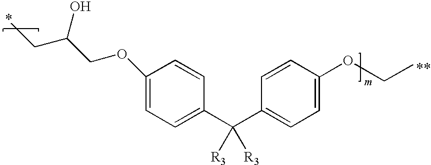
wherein m is 0 to 10, R₃ is independently H or CH₃, and the end indicated with the double asterisk is bonded to the epoxide group.

7. The composition of claim 1 wherein the matrix is a wax.

8. The composition of claim 7 wherein the wax is a saturated alkanecarboxylic acid having 12-40 carbon atoms.

9. The composition of claim 8 comprising up to 85 wt. % based on the weight of the composition of an aliphatic fatty acid wax, or a synthetic microcrystalline wax having a C22-C38 alkyl chain.

10. The composition of claim 1 wherein the particle is selected from aramid, polyester, polyamide, cellulose, glass, and carbon.

11. The composition of claim 1 wherein the particle is selected from chopped fiber, staple fiber, and pulp.

12. The composition of claim 1 wherein the particle is a poly(p-phenylene-terephthalamide) or a co-poly-(paraphenylene/3,41-oxydiphenylene terephthalamide) fiber.

13. The composition of claim 1 wherein the particle is a fiber which is pre-treated with a sizing.

14. The composition of claim 1 wherein the coating amounts 0.5-50 wt. % based on the weight of composition.

15. A particle-elastomer composition comprising:
(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of the composition of claim 1.

16. A skim product comprising the particle-elastomer composition of claim 15 and a skim additive.

17. A tire comprising the composition of claim 15.

18. A tire tread, undertread, or belt comprising the particle-elastomer composition of claim 15.

19. A tire comprising the skim product of claim 16.

20. A tire tread, undertread, or belt comprising the skim product of claim 16.
